(19) United States
(12) Patent Application Publication
(10) Pub. No.: US 2002/0022925 A1
(43) Pub. Date: Feb. 21, 2002

(54) Mobile navigation apparatus

(76) Inventor: Setsuo Okada, Chiba-shi (JP)

Correspondence Address: BIRCH STEWART KOLASCH & BIRCH, PO BOX 747, FALLS CHURCH, VA, 22040-0747, US

(21) Appl. No.: 09/840,078

(22) Filed: Apr. 24, 2001

(30) Foreign Application Priority Data
Apr. 24, 2000 (JP) P2000-123122

(51) Int. Cl. G01C 21/26

(52) U.S. Cl. 701/207; 340/995

(57) ABSTRACT

A mobile navigation apparatus comprises, computing means for computing the latitude and longitude information of the current location on the basis of radiowaves or the like received from satellites or ground stations, storage means for storing section information on a reference map, and display means for displaying the section information of the reference map corresponding to the current location and the current location itself, on the basis of the information from the computing means and the information stored in the storage means.

### BACKGROUND OF THE INVENTION

1. Field of the Invention

This invention relates to a mobile navigation apparatus.

2. Description of the Prior Art

A conventional navigation system for displaying a current location together with a map on display means such as a liquid crystal display has already been put into practical use. For example, car navigation systems for vehicular utilizing GPS (Global Positioning System) are widely available, wherein the current location can be identified by receiving radiowaves from satellites.

In the car navigation system of this kind, the detailed map information stored in a storage medium such as a CD-ROM or a DVD is used to display a desired destination, the current location, the route and so on in an comprehensive manner for the driver. And a figure showing the current traveling point of the vehicle along with the corresponding map information can be displayed on the liquid crystal display, on the basis of the latitude and longitude information which are calculated by radiowaves received from the GPS satellites.

However, such car navigation system has to be provided with readout means for reading data from the storage medium stored with the map information, a high-capacity memory for storing temporarily the readout data to be displayed, and a liquid crystal display having a relatively large area, so that it becomes a large-scale and expensive system. For this reason, to carry the system as a personal mobile apparatus was practically difficult.

### SUMMARY OF THE INVENTION

It is therefore an object of the present invention to provide a mobile navigation apparatus at a reasonable cost which enables a mobile apparatus having relatively limited specifications of memory capacity, display area and display information volume to be displayed to display the information necessary for the user to recognize the current location in a simple and easy way.

In order to attain the above-mentioned object, and according to one aspect of the present invention, a mobile navigation apparatus comprises: computing means for computing the latitude and longitude information of the current location on the basis of radiowaves or the like received from satellites or ground stations; storage means for storing section information on a reference map; and display means for displaying both the section information of the reference map corresponding to the current location and the current location itself, on the basis of the information from said computing means and the information stored in said storage means.

In addition, according to another aspect of the present invention, a mobile navigation apparatus comprises: computing means for computing the latitude and longitude information of the current location on the basis of radiowaves or the like received from satellites or ground stations; storage means for storing bibliographic information and section information on a reference map; and display means for displaying the bibliographic information and the section information of the reference map corresponding to the current location and the current location itself, on the basis of the information from said computing means and the information stored in said storage means.

Moreover, according to a further aspect of the present invention, a mobile navigation apparatus comprises: computing means for computing the latitude and longitude information of the current location on the basis of radiowaves or the like received from satellites or ground stations; storage means for storing bibliographic information, page information and section information on a reference map; and display means for displaying the bibliographic information, the page information and the section information of the reference map corresponding to the current location and the current location itself, on the basis of the information from said computing means and the information stored in said storage means.

Furthermore, according to a still further aspect of the present invention, a mobile navigation apparatus comprises: a receiver unit receiving radiowaves or the like from satellites or ground stations; a computing unit computing the latitude and longitude of the current location of a user on the basis of an output from the receiver unit; a storage unit storing at least section information on a reference map carried by the user; and a display displaying specific section information of the reference map corresponding to the current location and the current location itself; wherein the section information is correlated with the latitude and longitude information so that the computing unit reads out the specific section information from the storage unit thereby displaying on the display the specific section information and a pinpoint of the current location relative to the specific section information.

### BRIEF DESCRIPTION OF THE DRAWINGS

The invention will be explained in more detail in conjunction with appended drawings, wherein:

FIG. 1 is a diagram of a mobile navigation apparatus in accordance with a preferred embodiment of the present invention;

FIG. 2 is an exterior view of a mobile navigation apparatus;

FIG. 3 is an explanatory view showing a display example of the current location on display means;

FIG. 4 is an explanatory view showing another display example of the current location on the display means.

### DETAILED DESCRIPTION OF THE PREFERRED EMBODIMENT

Referring to drawings, a preferred embodiment of the present invention will be described below.

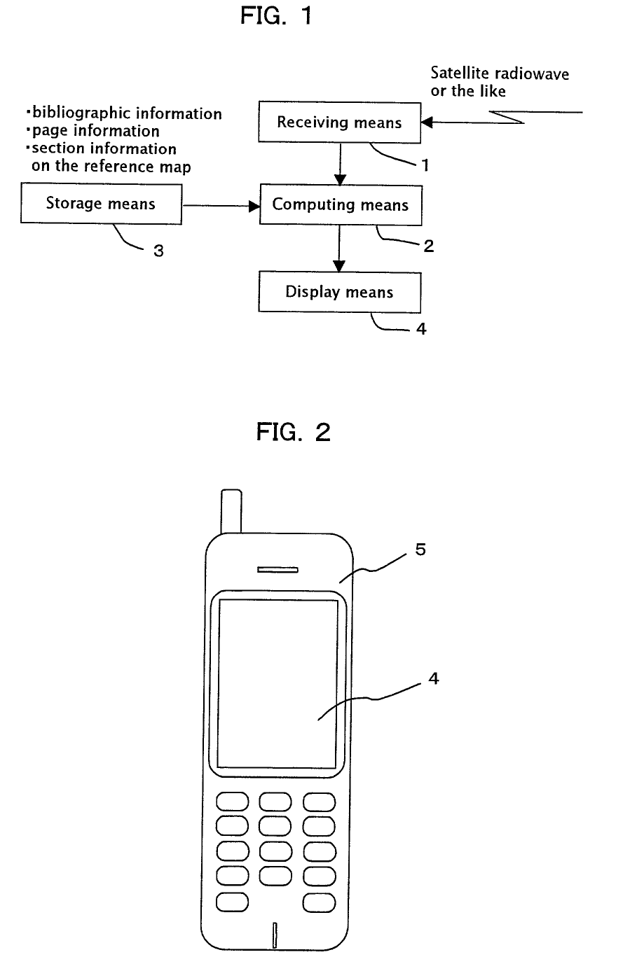

FIG. 1 shows a mobile navigation apparatus in diagramatic view according to a preferred embodiment of the present invention. The mobile navigation apparatus is provided with receiving means 1, computing means 2, storage means 3 and display means 4. FIG. 2 shows a mobile navigation apparatus 5 in exterior view, in which the aforementioned components of the mobile navigation apparatus and basic components necessary for a mobile phone are integrated. Here, no specific limitations are made on the addition of any functions other than the mobile navigation apparatus and on the exterior and shape thereof, thereby it may be applied to a wrist watch type or the like as well as the mobile phone type.

The receiving means 1 receives radiowaves from satellites or ground stations via an antenna, converts into electric signals and inputs them to the computing means 2.

On the basis of the input from the receiving means 1, the computing means 2 calculates the latitude and longitude of the current location where the radiowaves have been received, and outputs the data.

The storage means 3 is a memory such as a ROM or an EPROM which stores bibliographic information, page information and section information on reference maps of an atlas available as printed matters, wherein the page information and section information are correlated with the latitude and longitude data.

A memory card may also be used as the storage means 3. The memory card can be removably attached to the mobile navigation apparatus 5 so that information of these kinds can be advantageously written and rewritten by using an external personal computer or another apparatus.

When the reference map is an atlas, an example of the bibliogaphic information and the page information to be stored in the storage means 3 includes the name of the atlas (e.g., “1/10,000 of Geographical Survey Institute” or “1/25,000 of Geographical Survey Institute”) and the page numbers of the atlas.

In case that the reference map is a sheet of topographic map or the like, the bibliographic information and the section information mentioned below may be stored in the storage means 3, whereas the page information is omitted from storage. When the user predetermines a sheet of reference map for confirming the current location more precisely, it is obvious to say that the section information mentioned below is stored in the storage means 3, whereas the bibliographic information and the page information on the reference map is omitted from storage.

On the other hand, an example of the section information to be stored in the storage means 3 includes series of symbols (e.g., A, B, C, . . . ) and numerals (1, 2, 3, . . . ) that are printed at a generally equal interval on the vertical/horizontal edges of a map appeared on a certain page of a predetermined page number. One section can be specified from among a plurality of sections divided into grids by the combination of those symbols and numerals such as (A, 1) and (B, 2).

The bibliographic information, the page information and the section information preferably comprise text based data. Hence, the memory capacity necessary for the storage means 3 can be reduced to a low value while eliminating the storage of large-size image data.

Here, at least the data of the page numbers and the data of the symbols and numerals for specifying the sections are so stored that they are correlated with the data of the latitude and longitude on the reference map. Therefore, by using the data of the latitude and longitude of the current location calculated by the computing means 2 as keys, the data of the page numbers and the data of the symbols and numbers necessary for specifying a section, which are correlated with the latitude and longitude data, can be read from the storage means 3. The data of the bibliographic information, the data of the page numbers and the data of the symbols and numerals for specifying the section thus read are input to the display means 4, together with the data of the latitude and longitude of the current location.

The display means 4, such as a liquid crystal display, displays the bibliographic information, the page information and the section information of the reference map corresponding to the current location, and the current location simply on the basis of the data thus input.

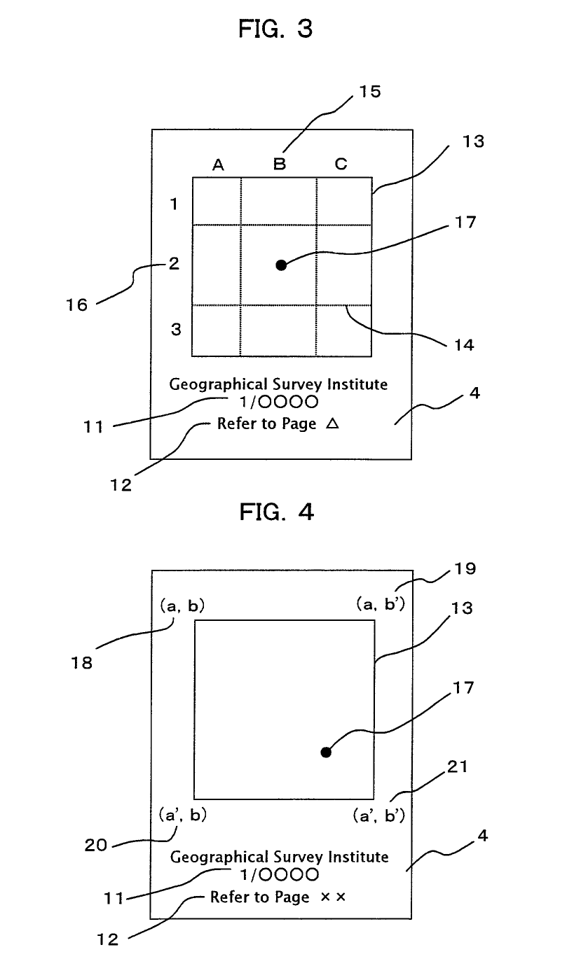

FIG. 3 is an example of how the current location is shown on the display means 4. Here are displayed bibliographic information 11, page information 12, frame lines 13, section lines 14, symbols 15 and numerals 16 specifying the sections, and a current location mark 17 blinking at a predetermined time interval.

The user prepares a separate reference map so as to confirm the current location more precisely on the reference map, while the mobile navigation apparatus 5 displays the current location. The bibliographic information, the page information and the section information on the reference map have already been stored in the storage means 3.

In this display example, the user can be informed, by the bibliographic information 11 and the page information 12 from among the information displayed on the display means 4, of the fact that the user should refer to “page [symbol] ” of the reference map “Geographical Survey Institute 1:◯◯◯◯”. Likewise, by the symbol 15 and the numeral 16 specifying the section, the user can recognize the section on the reference map as corresponding to the specified section. As a result, the page and the section on the reference map are specified so that the current location can be confirmed more precisely on the reference map on the basis of the positional relation of the current location mark 17 to the section displayed on the display means 4.

FIG. 4 is another display example of how the current location is shown on the display means 4. Here are displayed the bibliographic information 11, the page information 12, the frame lines 13, and the latitudes and longitudes 18, 19, 20 and 21 of the respective corner portions of the frame lines 13, and the current location mark 17 blinking at a predetermined time interval.

At least the data of the page numbers and the data of the symbols and numerals specifying the sections are correlated with the latitude and longitude data on the reference map and stored in the storage means 3, as has already been described. Therefore, the latitude and longitude data can be used as another method for specifying the section containing the current location.

In this display example, the user can be informed, by the bibliographic information 11 and the page information 12 from among the information displayed on the display means 4, of the fact that the user should refer to “page XX” of the reference map “Geographical Survey Institute 1:◯◯◯◯”. Likewise, by the latitudes and longitudes “(a, b), (a, b′), . . . ” of the respective corner portions of the frame lines 13, the user can recognize the latitude and longitude of the section surrounded by the displayed frame lines. As a result, the page and the section on the reference map are specified so that the current location can be confirmed more precisely on the reference map on the basis of the positional relation of the current location mark 17 to the section displayed on the display means 4.

According to the mobile navigation apparatus of the preferred embodiment, in addition to carrying a reference map, the user store the bibliographic information, the page information and the section information on the reference map so carried beforehand, thereby the current location can be simply displayed without resorting to a large-scale and expensive system such as a conventional car navigation system. Moreover, the user is able to confirm the current location more precisely on the reference map, as specified on the display means, by referring to that map.

Accordingly, when the user walks on street corners, climbs or traverses on mountain areas, or sails in the seas or lakes on a boat, for example, the user is able to confirm the current location precisely on a specific reference map such as a topographic map, a coastal sea area map or a lake map with reference to the information displayed on the display means of the mobile navigation apparatus, by carrying the reference map of the area to travel. With the conventional car navigation system, it is difficult in fact to confirm the current location in the mountainous area or on the sea or lake. According to the mobile navigation apparatus of the present invention, however, such problems can be solved by using the apparatus together with the reference map.

Meanwhile, the information to be stored in the storage means according to the present invention comprises the section information (containing the bibliographic information, or both the bibliographic information and the page information, if necessary) that can be formed of text based data, so that the memory capacity necessary for the storage means can be reduced while eliminating the storage of the large-size image data. Thus, even the mobile apparatus having relatively limited specification of display area and display information volume can display simply and comprehensively the information necessary for grasping the current location.

According to the invention, as has been described hereinbefore, it is possible to provide such a mobile navigation apparatus at a reasonable cost which easily enables a mobile apparatus having relatively limited specification of memory capacity, display area and display information volume to simply display the information necessary for the user to recognize the current location.

The preferred embodiment of the present invention has been disclosed by way of example and it will be understood that other modifications may occur to those skilled in the art without departing from the scope and the spirit of the appended claims.

What is claimed is:

1. A mobile navigation apparatus comprising:
computing means for computing the latitude and longitude information of the current location on the basis of radiowaves or the like received from satellites or ground stations;
storage means for storing section information on a reference map; and
display means for displaying both the section information of the reference map corresponding to the current location and the current location itself, on the basis of the information from said computing means and the information stored in said storage means.

2. The mobile navigation apparatus according to claim 1, wherein the section information includes series of symbols and numerals, the respective symbols and numerals corresponding to those printed on the vertical/horizontal edges of the reference map to specify respective sections.

3. The mobile navigation apparatus according to claim 1, wherein the section information includes latitude and longitude data.

4. A mobile navigation apparatus comprising:
computing means for computing the latitude and longitude information of the current location on the basis of radiowaves or the like received from satellites or ground stations;
storage means for storing bibliographic information and section information on a reference map; and
display means for displaying the bibliographic information and the section information of the reference map corresponding to the current location and the current location itself, on the basis of the information from said computing means and the information stored in said storage means.

5. The mobile navigation apparatus according to claim 4, wherein the section information includes series of symbols and numerals, the respective symbols and numerals corresponding to those printed on the vertical/horizontal edges of the reference map to specify respective sections.

6. The mobile navigation apparatus according to claim 4, wherein the section information includes latitude and longitude data.

7. A mobile navigation apparatus comprising:
computing means for computing the latitude and longitude information of the current location on the basis of radiowaves or the like received from satellites or ground stations;
storage means for storing bibliographic information, page information and section information on a reference map; and
display means for displaying the bibliographic information, the page information and the section information of the reference map corresponding to the current location and the current location itself, on the basis of the information from said computing means and the information stored in said storage means.

8. The mobile navigation apparatus according to claim 7, wherein the section information includes series of symbols and numerals, the respective symbols and numerals corresponding to those printed on the vertical/horizontal edges of the reference map to specify respective sections.

9. The mobile navigation apparatus according to claim 7, wherein the section information includes latitude and longitude data.

10. A mobile navigation apparatus comprising:
a receiver unit receiving radiowaves or the like from satellites or ground stations;
a computing unit computing the latitude and longitude of the current location of a user on the basis of an output from the receiver unit;
a storage unit storing at least section information on a reference map carried by the user; and
a display displaying specific section information of the reference map corresponding to the current location and the current location itself;
wherein the section information is correlated with the latitude and longitude information so that the computing unit reads out the specific section information from the storage unit thereby displaying on the display the specific section information and a pinpoint of the current location relative to the specific section information.

11. The mobile navigation apparatus according to claim 10, wherein the section information includes series of symbols and numerals, the respective symbols and numerals corresponding to those printed on the vertical/horizontal edges of the reference map to specify respective sections.

12. The mobile navigation apparatus according to claim 10, wherein the section information includes latitude and longitude data.
